(19) United States
(12) Patent Application Publication
(10) Pub. No.: US 2002/0054750 A1
(43) Pub. Date: May 9, 2002

(54) DVR functions status indicator

(76) Inventors: Michael Ficco, Silver Spring, MD (US); Robert Davis, Woodbine, MD (US); Adrian Yap, Gaithersburg, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 09/761,203

(22) Filed: Jan. 17, 2001

Related U.S. Application Data
(60) Provisional application No. 60/199,438, filed on Apr. 25, 2000.

(51) Int. Cl. H04N 5/76

(52) U.S. Cl. 386/46; 386/83

(57) ABSTRACT

An apparatus, method and system for displaying the status of a recording device such as a set top box (STB) equipped with a digital video recorder (DVR) includes a memory that stores status parameters indicating functionality of the STB-equipped with DVR, and a processor for controlling the display of these status parameters based on receiving user commands to access the memory and display at least a selected one of the status parameters for review. A suitable user command interface may be used in order to transmit a command to display desired status parameter(s). Status parameters displayed include the time that a recording is behind a live feed, whether a program being viewed is live or recorded, available storage capacity for recording, visual/audiovisual alerts indicating various levels of storage available for recording, and other file attributes associated with the functionality and operation of the STB-equipped with DVR.

### RELATED APPLICATION(S)

This application claims the benefit under 35 U.S.C. Section 119(e) of a U.S. Provisional Patent Application by Adrian Yap et al. entitled “DIGITAL VIDEO RECORDER”, Ser. No. 60/199,438, filed on Apr. 25, 2000, the entire contents of which is incorporated by reference herein.

### BACKGROUND OF THE INVENTION

1. Technical Field of the Invention

This invention generally relates to applications and features related to digital recording devices. More particularly, the present invention is directed to a status display apparatus and method that enables a viewer to monitor various functions or status parameters of a set top box (STB) equipped with a digital video recorder (DVR).

2. Description of Related Art

Conventional communications systems may include a receiver for receiving and processing transmitted waveforms. For example, in a satellite communications system, the receiver may include a small satellite dish connected by a cable to a set-top box (STB) or an integrated receiver-decoder (IRD), which are used as interchangeable terms in the art. The satellite dish is aimed toward the satellites, and the STB is connected to the user's television in a similar fashion to a conventional cable-TV decoder.

A micro-controller controls the overall operation of the STB, including the selection of parameters, the set-up and control of components, channel selection, viewer access to different programming packages, blocking certain channels, and many other functions. The compression and decompression of packetized video signals may be accomplished according to the Motion Picture Expert Group (MPEG) standards and the compression and decompression of audio signals may be accomplished according to the Motion Picture Expert Group (MPEG) standards, DOLBY DIGITAL (or AC-3) standards, DTS or other known standards. The conventional STB also typically includes video and audio decoders in order to decompress the received compressed video and audio. The STB may output video and audio data to a number of destinations, including audio and video decoders, ports, memories, and interface devices, such as a digital VHS (DVHS) interface. The STB may send the same audio and video data to different destinations.

Recently, due to the advances in digital technology and with a goal of creating greater personalized television for viewers, the STB has become embodied as part of a digital VCR (DVCR) an/or digital VHS (DVHS) receiver for example, in the continuing development of digital video recording devices. These devices incorporate a host of both traditional and powerful new features. For example, these features may include high quality digital A/V, the ability to pause/rewind live video and/or audio programs as they are broadcast, multi-speed fast forward and fast rewind, instant replay, slow motion and frame by frame advance. Additionally, the viewer may have access to, and have the ability to manipulate or develop an electronic program guide of listings.

Such digital video recording devices allow sports fans and movie buffs alike to have full control of live television programs and sporting events in full digital-quality. Viewers may also be able to create customized programming by searching for, and recording, programs that match their preferences by actor, director, keyword or any combination of content searches. Combined with the wide variety of program selections, viewers may find exactly what they are looking for and even create their own “TV channels” based on their favorite programming.

The electronic program guides generally may be displayed as a menu on a screen of a TV for example. Operation of push buttons or keys of a remote control may display a series of menu screens having an array of cells corresponding to particular programming events, channels, TV programs, etc. The viewer may scroll through the cells to choose a particular program, pull up another sub menu to find out more information on a particular program, or pull up a sub menu with additional options.

However, none of these recent digital video recording devices provide the ability to monitor the status or condition of certain internal system parameters or functions, such as the status of storage capacity in the digital video recording device, recording time available or remaining, or whether a program being viewed is live or recorded, for example. Accordingly, there is a need for a status display that a user or viewer may access, and/or for visual status indicators that are automatically, or by user direction, are displayed on a display device to allow the viewer to monitor or check the status of certain operational parameters of the digital video recording device.

### SUMMARY OF THE INVENTION

The present invention is directed to a apparatus and method for displaying the status of a recording device such as a set top box (STB) equipped with a digital video recorder (DVR). The apparatus includes a memory that stores status parameters indicating functionality of the STB-equipped with DVR, and a processor for controlling the display of these status parameters based on receiving user commands to access the memory and display at least a selected one of the status parameters for review and/or manipulation by the viewer on a display device operatively connected to the STB-equipped with DVR. A suitable interface such as a remote control may be used in order to transmit a command to display desired status parameter(s).

Status parameters or features related to the operation of the STB-equipped with DVR that may be displayed include the time that a recording of a live feed is behind a live feed when the STB-equipped with DVR is in a pause mode, whether a program being viewed is live or recorded, available storage capacity for recording and or remaining available record time, visual or audiovisual alerts indicating various levels of storage available for recording, and other file attributes associated with the functionality and operation of the STB-equipped with DVR.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exemplary arrangement of a set-top box (STB) within a direct broadcast satellite or digital video broadcast system in accordance with the invention;

FIG. 2 illustrates a general data flow in a direct broadcast satellite or digital video broadcast system in accordance with the invention;

FIG. 3 is a block diagram of an exemplary architecture of the STB-equipped with DVR;

FIG. 4 is a block diagram showing an exemplary construction of a memory device according to the invention;

FIG. 5 is a flow diagram showing data flow for recording a program, broadcast or event for later playback in accordance with an exemplary embodiment of the invention;

FIG. 6 illustrates an alternative recording path in accordance with the invention;

FIG. 7 illustrates a partial block diagram of FIG. 3 to show an exemplary communication path between a remote and the host processor of the STB-equipped with DVR;

FIG. 8 illustrates the data flow to display a status parameter of the STB-equipped with DVR in accordance with the present invention;

FIG. 9 illustrates an exemplary status menu screen according to the invention;

FIGS. 10(a) through 10(c) illustrate several exemplary graphical objects that may represent the current delay status parameter of the invention;

FIGS. 11(a) and 11(b) illustrate exemplary graphical objects that may represent the live/recorded status indicator parameter of the present invention;

FIGS. 12(a) through 12(e) illustrate several exemplary graphical objects that may represent the disk gas gauge parameter of the invention;

FIGS. 13(a) through 13(c) illustrate several exemplary graphical objects that may represent the out-of-disk alert status parameter of the invention;

FIGS. 14(a) through 14(c) illustrate exemplary text messages of a status parameter related to program length versus recording time available;

FIG. 15 illustrates an exemplary status sub-menu screen related to certain file attributes according to the invention;

FIGS. 16(a) through 16(c) illustrate the information that may be displayed upon selection of cell 541 in FIG. 15;

FIGS. 17(a) through 17(c) illustrate the information that may be displayed upon selection of cell 542 in FIG. 15;

FIGS. 18(a) through 18(c) illustrate the information that may be displayed upon selection of cell 543 in FIG. 15;

FIGS. 19(a) through 19(c) illustrate the information that may be displayed upon selection of cell 544 in FIG. 15;

FIGS. 20(a) through 20(c) illustrate the information that may be displayed upon selection of cell 545 in FIG. 15;

FIGS. 21(a) through 21(c) illustrate the information that may be displayed upon selection of cell 546 in FIG. 15;

FIGS. 22(a)-(c) illustrate the information that may be displayed upon selection of cell 547 in FIG. 15; and

FIGS. 23(a) to 23(c) illustrates how a user in accordance with the invention may display a list of hidden files for selection.

### DETAILED DESCRIPTION

In accordance with the status display apparatus and method of the present invention, an STB equipped with a digital video recording device such as a digital video recorder (DVR) may have a plurality of status parameters that can be viewed and/or manipulated by a user on a screen of a display. The display may be of a status menu or status guide that is depicted on a TV or other display device, effected via a user command interface to the DVR, such as by operation of a remote control device to send commands to a processor within the DVR, for example, and manipulated via a graphical user interface (GUI) controlled by the processor.

Status parameters or features related to DVR functionality or operability may be accessed, displayed for viewing and/or manipulated by the user or viewer. These features may include current delay of recording behind live feed, live/recorded status indicator, mass storage device capacity (Disk Gas Gauge) of a mass storage device that is operatively connected to the STB equipped with DVR-and/or a display of remaining recording time available in minutes, for example, various out-of-disk space alerts, program length versus recording time available data, and other file attributes.

The current delay feature allows the user to see how far the recording is behind a live feed when pausing a signal of the live feed or broadcast. The live/recorded status indicator may be displayed to indicate whether material a viewer is watching is LIVE (a live feed) or RECORDED. In an embodiment, the live/recorded status indicator may flash LIVE or RECORDED on an output device.

The Disk Gas Gauge feature may indicate the percent of a mass storage device or storage medium that has been consumed by recorded material, and/or the amount of remaining time available for recording (in minutes, for example). These status parameters may be displayed numerically in conjunction with an icon or other uniquely shaped feature or figure on a specified area of a video monitor, TV or other display device operatively connected to the DVR for example. In fact, the various status parameters associated with the Disk Gas Gauge and other status parameters described herein may be displayed as any of an icon, animated icon, flashing text or figures, pie-chart, bar graph or other known or used graphical objects consistent with what is known in the art.

Additionally, as percent of storage consumed by recorded material reaches lower levels, different video icons/shapes may be displayed to visually alert the viewer, and are hereinafter collectively termed as “out-of-disk space alerts”. For an out-of-disk space alert, the user may receive a notification indicating the approximate minutes of recording time still available while recording is in progress. In another embodiment, if the program length is greater than the amount of unused storage space available, the user may receive a notification indicating such, as well as the recording time available, prior to or at the start of the recording.

Further, other file attributes of the DVR may be selected via the GUI. These may include the date a program is recorded, the latest or last date a stored program has been accessed, size of a recorded or live program in Mbytes, length of a live or recorded program in minutes, implementation of a protect feature to prevent erasure of a recorded program, save options designating how much of a program is to be recorded and/or how long of a time a program is to be stored before being erased, and implementation of a hidden file feature to prevent titles of certain programs, such as those of an explicit nature, for example, from being displayed within the program guide.

Therefore, the present invention enables a viewer to be provided with a display of the aforementioned status parameters of his or her own set-top box STB equipped with DVR, within a direct broadcast satellite or digital video broadcast (DVB) system. Accordingly, the viewer may be able to have a better understanding of what programs he or she may be able to record, or be alerted that some of the previously recorded material may have to be erased in order to provide room for recording a desired event, program or broadcast that exceeds to current storage capacity of a mass storage device. As will be explained in further detail later in this disclosure, the user or viewer simply sends commands to a processor within the STB equipped with DVR in order to display the desired status parameter(s). Moreover, a menu screen of status parameters or status program guide may be displayed, providing a plurality of status parameter options or data available for selection by the user.

However, before describing the above features in greater detail, the inventors offer a general discussion on the overall satellite-based distribution system envisioned for the present invention, and more specifically discuss a set-top box (STB) equipped with a digital video recorder (DVR) within a direct broadcast satellite or digital video broadcast (DVB) system. Additionally, the basic architecture and operation of the STB-equipped with DVR is explained in order to provide a context for the status display method and apparatus of the invention, which enable a viewer to monitor various functions or parameters of a STB-equipped with DVR on a display device operatively connected thereto.

In general, television signal distribution systems generally rely on either a cable network or on free-space propagation for delivering television signals to individual users or subscribers. Cable-based television systems transmit one or more individual television signals or “channels” over wire, while free-space propagation systems transmit one or more channels over-the-air, i.e., in a wireless manner. Most large-scale cable and wireless television signal distribution systems broadcast a broadband television signal having a plurality of individual television signals or channels modulated onto one or more carrier frequencies within a discernable frequency band.

Some wireless television signal distribution systems use one or more geosynchronous satellites to broadcast a broadband television signal to receiver units within a large geographic area, while other wireless systems are land-based, using one or more transmitters located within smaller geographic areas to broadcast to individual receiver units within those geographic areas. An example of a land-based “cellular” type television signal distribution system is disclosed in Bossard, U.S. Pat. No. 4,747,160. This system includes multiple television signal transmitting stations, each of which transmits a television signal to individual receivers spread throughout a limited geographic region, and is configured so that adjacent transmitting stations use modulation and frequency diversity to prevent interference.

Some cellular systems, such as those commonly referred to as LMDS (local multi-point distribution system) and MMDS (multi-channel, multi-point distribution system), use a land-based cellular-type transmitting setup to rebroadcast satellite signals at frequencies different than the frequencies used by the satellite. Each of the transmitters of an LMDS system typically transmits within a one to five mile radius cell while each of the transmitters of an MMDS system typically transmits within an approximately 30-mile radius cell.

The present invention may be embodied in a satellite-based distribution system. The system generally includes an earth station that compiles a number of programs (video and audio) into a broadband signal, modulates a carrier frequency band with the broadband signal and then transmits (uplinks) the modulated signal to a geosynchronous satellite via a transmit antenna. The satellite amplifies the received signal, shifts the signal to a different carrier frequency band and transmits (downlinks) the frequency shifted signal to earth for reception at individual receiver stations.

The uplink and downlink broadband signals of the disclosed satellite distribution system may be divided into a plurality of transponder signals, each having a plurality of individual channels. For example, analog satellite systems operating in the so-called “G-band,” i.e., between about 3.7 GHz and about 4.2 GHz, typically broadcast ten (10)-500 MHz-wide transponder signals, with each transponder signal further including twelve, 40 MHz-wide analog channels. Satellite systems may also broadcast a set of transponder signals at multiple polarizations, for example, a right-hand circular polarization (RHCP) and a left-hand circular polarization (LHCP), within the band of carrier frequencies associated with the satellite; effectively doubling the number of channels broadcast by the system.

Satellite-based signal distribution systems exist for many frequency bands, including the so-called “Ku-band” which ranges from approximately 12 GHz to approximately 18 GHz. The preferred embodiment of the present invention uses an uplink signal having 16 RHCP transponder signals and 16 LHCP transponder signals modulated into the frequency band between about 17.2 GHz and about 17.7 GHz. Each of these 32 transponder signals includes data packets related to approximately 10 individual television channels associated therewith. The satellites shift the uplink transponder signals to carrier frequencies ranging from approximately 11.7 GHz to approximately 12.2 GHz and transmit these frequency-shifted transponder signals back to earth for reception at each of a plurality of individual receiver stations.

Each receiver station may include an antenna coupled to an STB that is equipped with a digital video recorder (DVR). In another embodiment, the STB may have interface circuitry coupled thereto for connection to an external digital peripheral unit such as a storage medium.

The antenna may comprise a parabolic dish antenna such as an outdoor unit (ODU) for example, pointed in the general direction of the transmitting satellite (or other transmitting location) to thereby receive the broadband signal. Such antennas may also include a low-noise block (LNB) downconverter, which filters and shifts the incoming signal to an intermediate frequency band, such as L-band, which is between approximately 1.0 GHz and approximately 2.0 GHz. In one embodiment, the signal received from the satellite is shifted to the frequency band between approximately 950 MHz and approximately 1450 MHz.

Sometimes, only the RHCP transponder signals or the LHCP transponder signals are mixed down to L-band, depending on which channel a user is viewing. However, in systems having a two-channel LNB downconverter, both the RHCP and the LHCP transponder signals are shifted down to L-band and provided, via separate lines, to the receiver station.

Although the present invention will be explained in reference to a STB within a direct broadcast satellite or digital video broadcast (DVB) system, the STB and/or STB-equipped with DVR may function within any of a cable TV, off-air broadcast or other applicable or known and used communication-related and/or wireless digital-TV system.

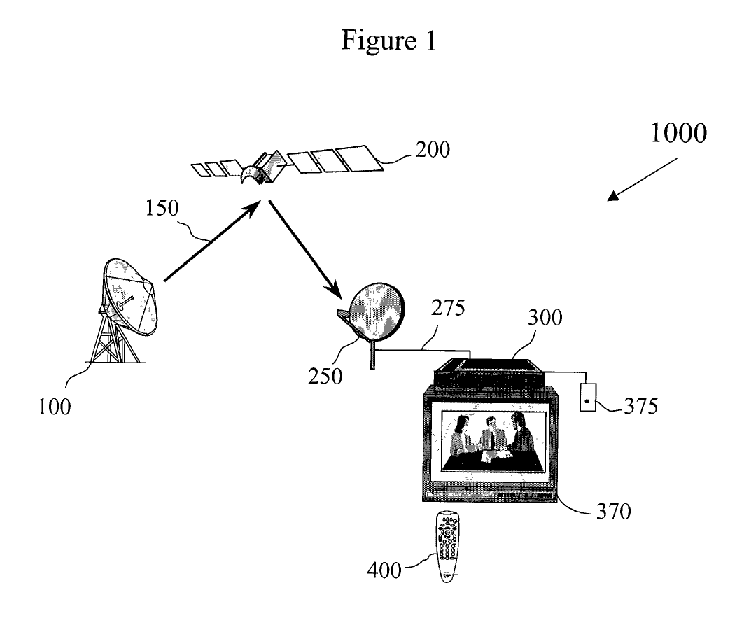

FIG. 1 is an exemplary arrangement of a STB 300 equipped with a DVR within a direct broadcast satellite or digital video broadcast (DVB) system, in accordance with the present invention. In the exemplary embodiment of FIG. 1, the system 1000 may comprise a transmit antenna station (hereinafter referred to as uplink facility 100 for clarity), satellite 200, receive antenna 250 and STB 300 equipped with DVR.

The transmit antenna station may be a DIRECTV satellite uplink facility, for example, or any other earth station, broadcast cable or broadband transmission system or facility as is known in the art. The bitstream (airlink 150) is a suitable content signal such as a digital audio and video television data signal (A/V signal), the medium is a satellite 200, and the receive antenna 250 is preferably an outdoor unit (ODU). As illustrated in FIG. 1, the ODU is connected to STB 300 via coaxial cable 275.

In this exemplary embodiment, the DVR of the present invention is included in, or subsumed within STB 300. However, the invention is applicable to any STB having a multiple-processor configuration. STB 300 may further be connected to a display 370, such as a standard definition television, a high definition television or a PC monitor and also may be connected to a telephone line 375. The DVR-equipped STB 300 may be controlled via a remote control 400 as is well known in art, using known RF and/or IR transmission and reception techniques.

The user command interface in the present invention however is not limited to a remote control device. Alternatively, any of function buffons residing on the STB or DVR structure itself, a keyboard operatively connected thereto and/or connected to a PC that is in communication with the STB, USP serial ports, voice-activation software devices within or operatively connected to the STB, or command and/or instructions by remote call-in using DTMF tones for example, may be substituted as the user command interface to the STB or DVR.

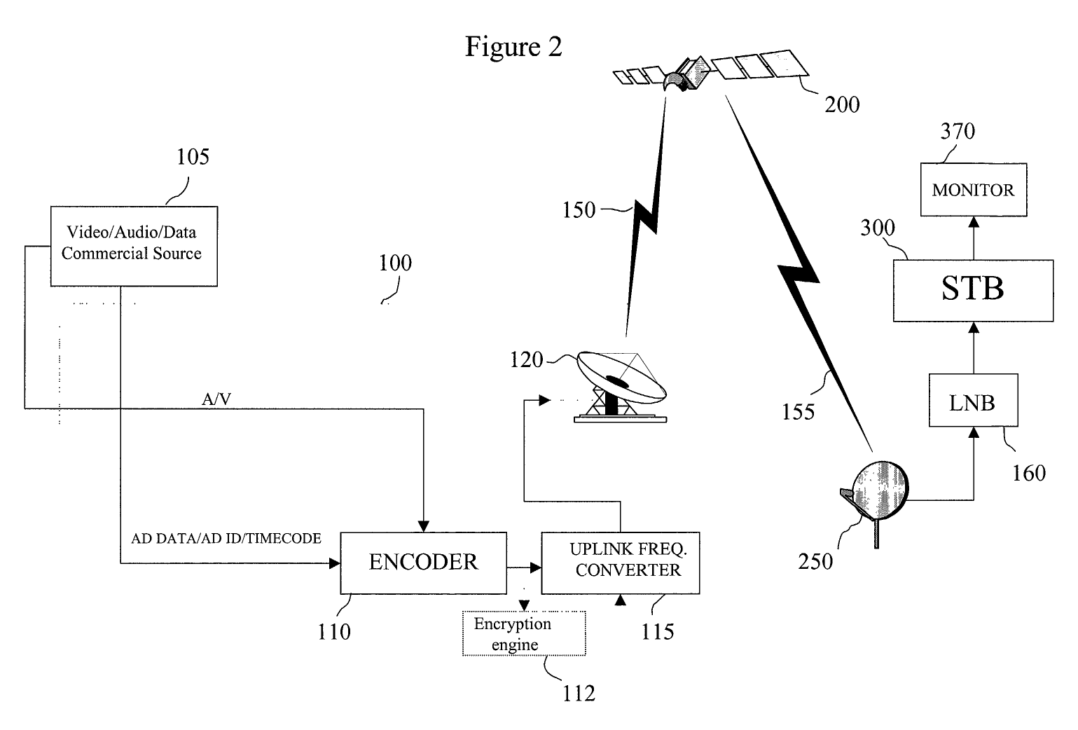

FIG. 2 illustrates the general data flow in a direct broadcast satellite or digital video broadcast system. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 110 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 which converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

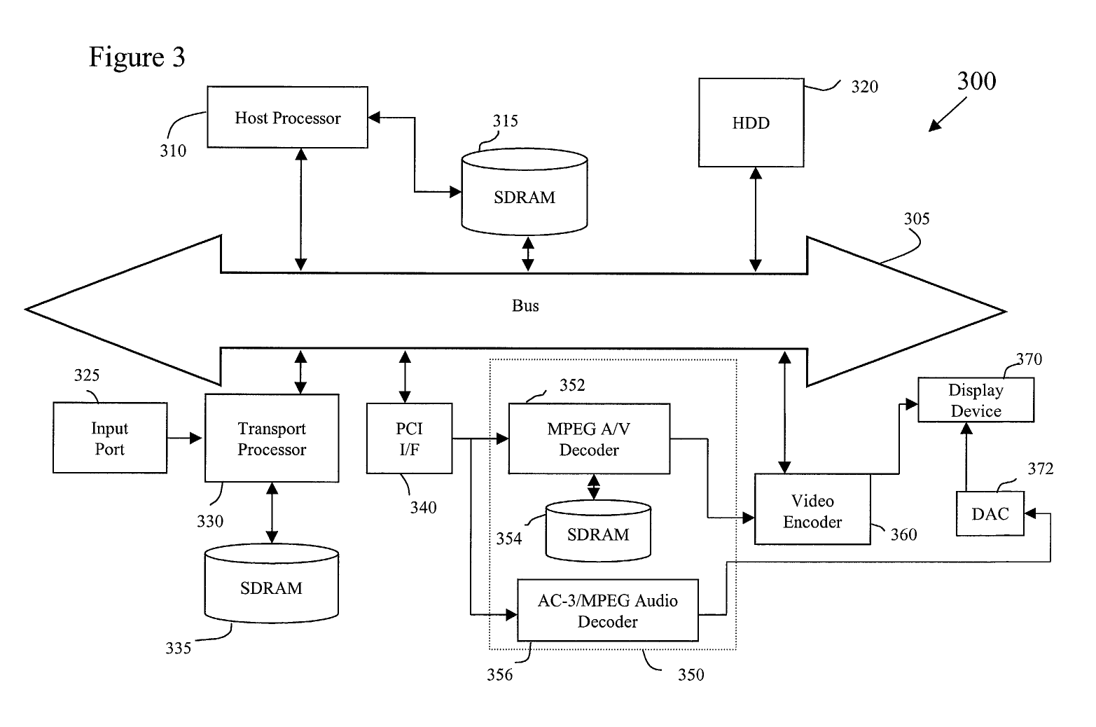

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 3) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

FIG. 3 illustrates an exemplary architecture of the STB 300 that is capable of performing background caching of encrypted programming for later playback in accordance with the present invention. The STB 300 utilizes a bus 305 to interconnect various components and to provide a pathway for data and control signals.

FIG. 3 illustrates a host processor 310, a memory device 315 (in an exemplary configuration embodied as an SDRAM 315) and a hard disc drive (HDD) 320 connected to the bus 305. In this embodiment, the host processor 310 may also have a direct connection to SDRAM 315 as shown in FIG. 3 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 3, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300, such as graphical-user interface and browser functions. A browser is a software engine that presents the interface to, and interacts with, a user of the STB 300. The browser is responsible for formatting and displaying user-interface components and pictures. Typically, the user interface is displayed as a Graphical User Interface (GUI).

Browsers are often controlled and commanded by the standard HTML language, which is used to position and format the GUI. Additionally, or in the alternative, any decisions and control flow of the GUI that requires more detailed user interaction may be implemented using JavaScript(tm). Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about 25 Gbytes, where preferably about at least 20 Gbytes is available for various recording applications, and the remainder flexibly allocated for pause applications in STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 3 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

The input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 3 has been described in conjunction with digital television, the signal supplied could be any type of television signal, any type of audio or video data, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the decryption may be performed instead by the host processor 310.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (A/V) data may be sent to the host processor 310's memory (SDRAM 315) while simultaneously being sent to an MPEG A/V decoder 352, as further discussed below.

Decoder 350 may be constructed as shown in FIG. 3 by including the MPEG A/V decoder 352 connected to the PCI I/F 340, as well as an AC-3/MPEG audio decoder 356 which is also connected to the PCI I/F 340. In this way, the video and audio bitstreams from the PCI I/F 340 can be separately decoded by decoders 352 and 356, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

Video encoder 360 is preferably an NTSC encoder that encodes, or converts the digital video output from decoder 350 into a coded analog signal for display. Regarding the specifications of the NTSC (National Television Standards Committee) encoder 360, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. SECAM uses the same bandwidth as PAL but transmits the color information sequentially. SECAM runs on 625 lines/frame.

Thus, although use of a video encoder 360 is envisioned to encode the processed video for display on display device 370, the present invention is not limited to the NTSC standard encoder. PAL and SECAM encoders may also be utilized. Further, hi-definition television (HDTV) encoders may also be viable to encode the processed video for display on a HDTV, for example.

Display device 370 may be an analog or digital output device capable of handling a digital, decoded output from the video encoder 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices which are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from video encoder 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV system or other known systems which can reproduce the encoded audio and/or video signals for reproduction and/or display. This may also include a PC that can play video or audio files containing the encoded A/V data sent from the STB 300, for example.

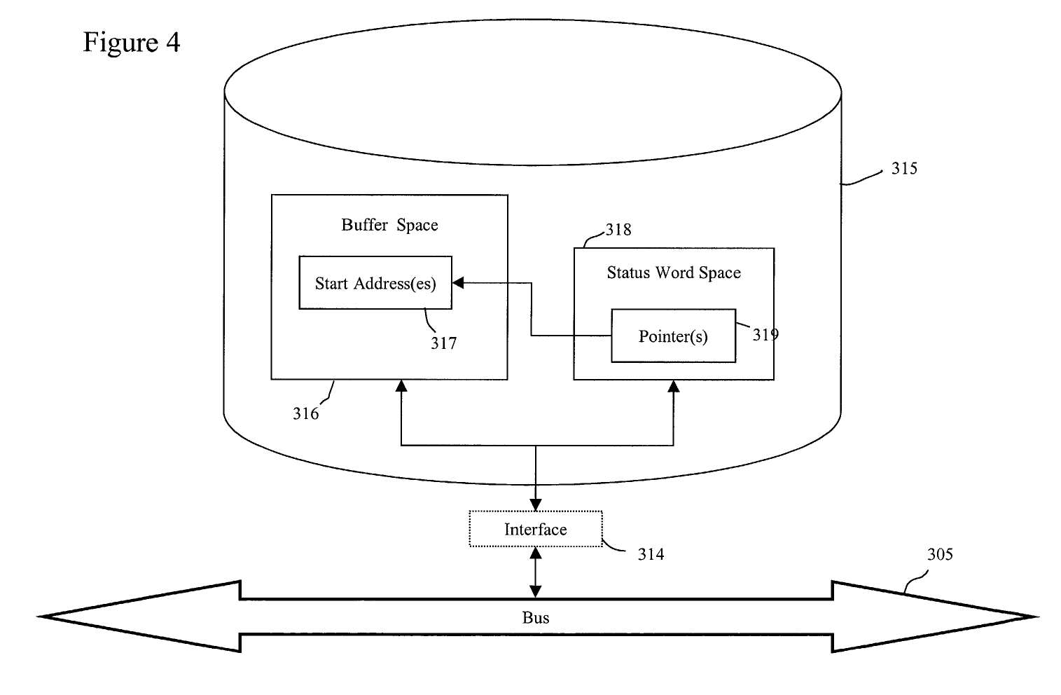

FIG. 4 illustrates various components that may be provided for the SDRAM 315. As mentioned above, the SDRAM shown in FIG. 3 is actually a specific implementation of a memory device. It is noted that the invention is not limited to this specific implementation of SDRAM 315 and can include any other known or future developed memory technology. Regardless of the technology selected, the memory device 315 may include a buffer space 316 which may be a fixed or virtual set of memory locations that buffers or otherwise temporarily stores audiovisual data. In practice, the video data may be stored separate from the audio data, but it would be possible to intermix these data types depending upon the particular application and coding techniques utilized for the audio and visual data.

The audio visual data stored in the buffer space 316 includes one or more start addresses 317 which indicate the beginning memory address at which the audio and/or video data (A/V) is stored. If the A/V data is separately stored, then a plurality of stored addresses will be necessary. Furthermore, if there is more than one set of, or a block of data within the buffer space 316, then the start addresses 317 will individually point to each block of data.

The memory device 315 also includes a status word space 318. This status word space includes fixed or virtual addresses at which status words may be stored. An example of a status word that may be stored in the status word space 318 is a status word summarizing the status of a peripheral device. For example, the status word that may be stored within the status word space 318 may include the status of the host processor 310 or transport processor 330. The status word space 318 may also include pointers 319 that point to the start addresses 317 within the buffer space 316.

As further shown in FIG. 4, the SDRAM 315 may connect to the bus 305 via an interface 314. The dash lines indicate that the interface 314 is optional and may or may not be included depending upon the interface requirements of the particular memory device 315 and/or bus 305.

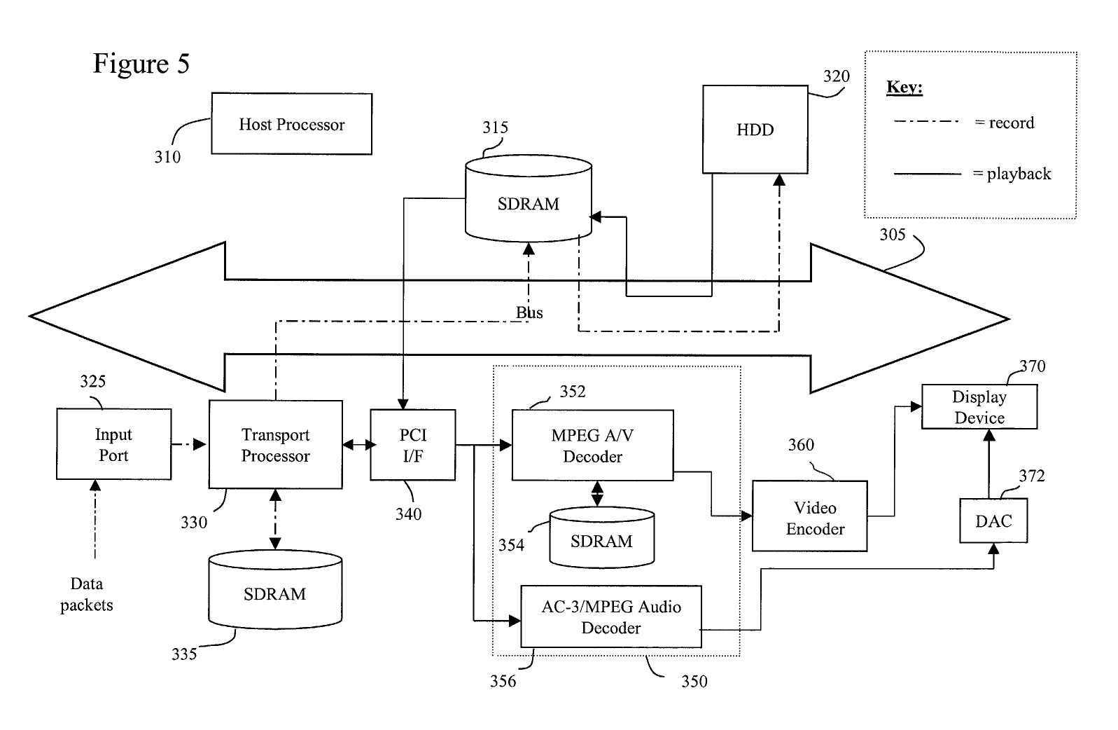

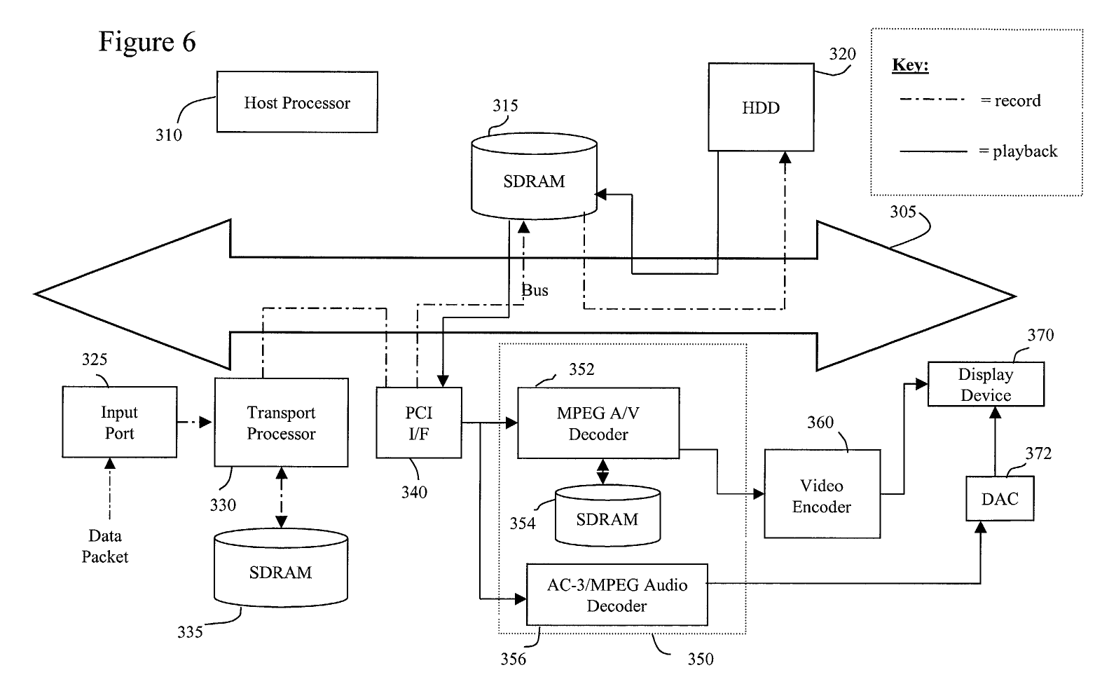

The recording and playback paths of the STB 300 are described in accordance with FIGS. 5 and 6. FIG. 5 shows the recording and playback data flows among the various components of the STB 300. Some of the connections between components, and associated reference numerals from FIG. 3 may have been eliminated in FIGS. 5 and 6 in order to highlight the data flow which is shown using dashed lines (see Key) in FIGS. 5 and 6.

As shown in FIG. 5, A/V data of a selected or desired event, program and/or broadcast is received by input port 325 (typically the data is received in packetized and encrypted form) and fed to the transport processor 330. The transport processor 330 then transfers the received A/V data to SDRAM 315. Digital recording is accomplished by the host processor 310, which transfers the A/V data buffered by SDRAM 315 to the HDD 320. In other words, the SDRAM 315 serves as a buffer that buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

FIG. 6 illustrates an alternative signal path for recording. Audiovisual data is fed from the input port 325 to the transport processor 330. The transport processor 330 then transfers the received audiovisual data to the PCI I/F 340, as indicated by the dashed data flow line. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that buffers data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, etc. in STB 300 is now described. Referring again to FIG. 5, when the viewer turns the STB 300 on, the viewer is given the option to playback any of the previously recorded programs, events, broadcast, etc. This may be done, for example, by using a remote control or other suitable user command interface (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 to transport processor 330, back to bus 305 and then to PCI I/F 340, which in turn sends the selected A/V data to decoder 350. More specifically, the video portion of the bitstream is sent to MPEG A/V decoder 352, with the audio portion being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to video encoder 360 for conversion to an analog format, so that it may be displayed on display device 370. From this point on, the playback data looks, for all intents and purposes, identical to the originally recorded event, program, broadcast, etc.

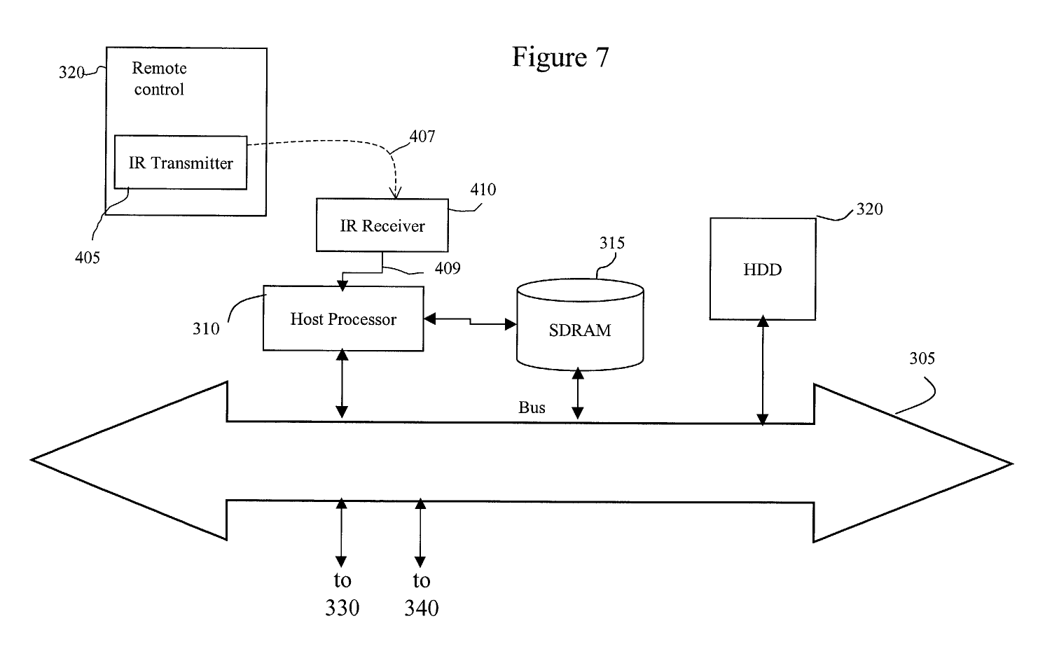

The architecture of the STB 300 and the operations of recording and playback having been described, a status display apparatus and status display method for the STB 300 equipped with DVR are now explained in light of the above description. FIG. 7 illustrates a partial block diagram of FIG. 3, so as to show an exemplary communication path between a remote control device and the host processor of the STB 300. In FIG. 7, there is illustrated a remote control device 400 which is in communication with the host processor 310. The remote control device may be a device that is specific to the STB 300, and/or may be a universal remote control device which controls various individual components connected within a home entertainment system (TV, stereo, tape deck, DVD player, CD player, STB, etc.)

As is well known in the art, the remote control device 400 may include a remote control transmitter 405 therein for transmitting various key or pushbutton-associated signals (commands) selected by the viewer or user. These are sent in the form of AN infrared (IR) ray signal 407 for example, to the STB 300, and in particular to an IR receiver 410 that may be operatively connected to host processor 310. IR receiver 410 decodes the received infrared ray signal 407, such as by photoelectric conversion for example, and sends a system drive signal 409 (which is preferably a digital signal) to host processor 310. The host processor 310 thus analyzes composed code information (i.e., the command data generated by the user) corresponding to the received system drive signal 409. This may be a command to display a desired status parameter or status feature, for example.

Although the above communication path and interface to the STB 300 is explained with regard to using a remote control device, commands and/or processing necessary to display status parameters may also be initiated by a user actuating buttons, switches and/or keys that may be provided on, and integral with STB 300. Moreover, these buttons, switches and/or keys may interact with software or package programs within STB 300 (i.e., provided within SDRAM 315, HDD 320 or as part of host processor 310) in order to effect display of a status parameter on a screen of a device. These alternative interfaces provide redundancy for the viewer, as well as alternative means to display a status parameter or function of STB 300 on a display device 370.

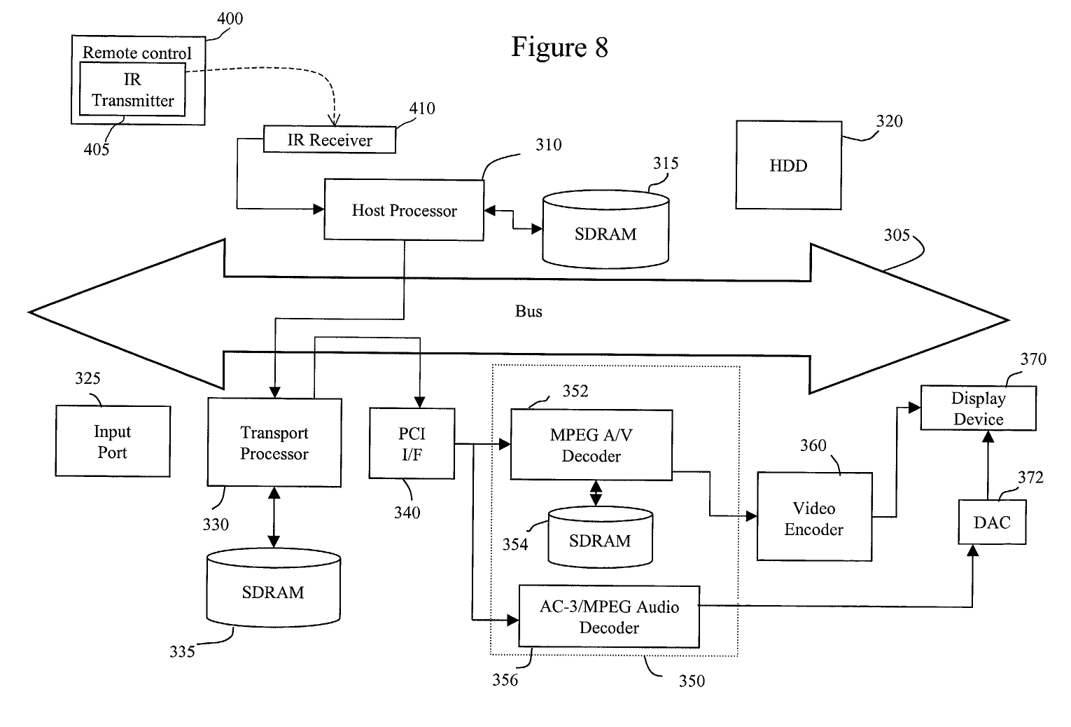

FIG. 8 illustrates the data flow to display a status parameter of the STB 300 in accordance with the present invention. A plurality of status parameters are stored in SDRAM 315. Additionally, certain ones of these stored status parameters may be updated to reflect current status of the STB 300; for example, remaining recording time available, current delay behind live feed, etc. This may be done, for example, by using designated software programs or predetermined algorithms within host processor 310.

The host processor 310 receives an IR ray signal (i.e., a command) from remote control device 400 that is converted into a digital signal. This signal is a command directing that a certain status parameter or status data be displayed. Thus, host processor 310 retrieves the ordered status parameter (this may be only digital video data or digital A/V data, depending on the selected status parameter and/or status feature) from SDRAM 315, and sends the selected A/V data corresponding to the desired status parameter via bus 305 to transport processor 330, and through PCI I/F 340, which in turn sends the A/V data of the selected status parameter to decoder 350. From this point, the flow path is identical to that for playback described above. The decoded A/V data is output to video encoder 360 for conversion to an analog format, so that the desired status parameter may be displayed on display device 370.

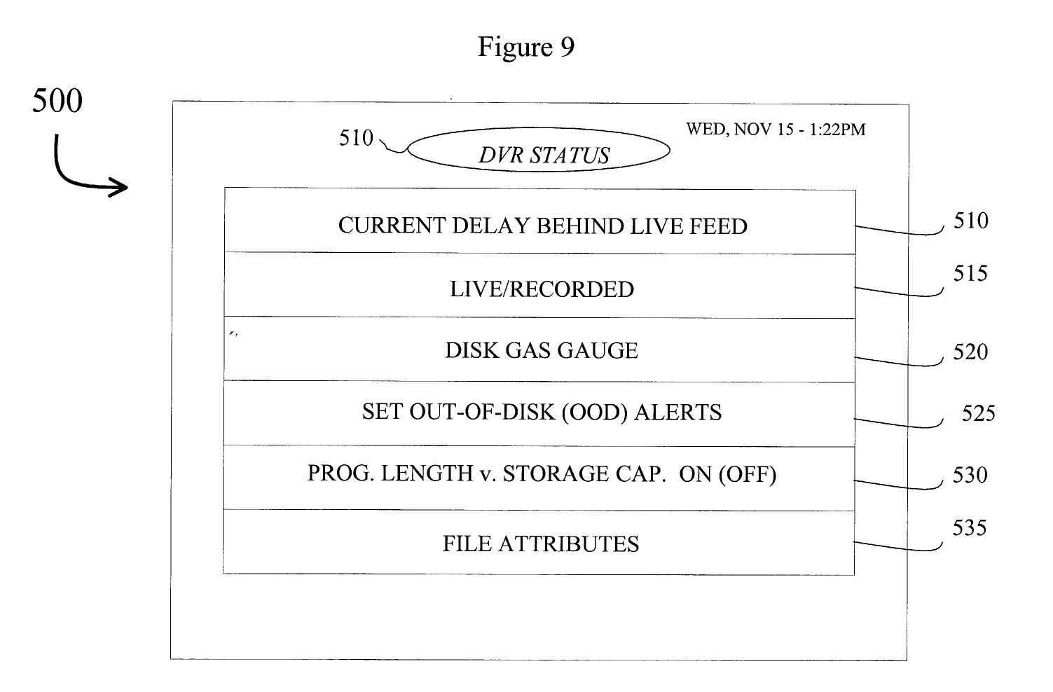

FIG. 9 illustrates an exemplary status menu screen according to the invention. When a user or viewer sends a command to display a status menu, an exemplary status menu 500 or status guide such as is depicted in FIG. 9 may be displayed on the screen of a display device 370. In an exemplary embodiment, various status parameters or features may be displayed in stacked cells or rows of the menu 500, each cell being assigned to a particular status parameter.

As shown in FIG. 9, a title line 505 such as “DVR Status” may be provided. The individual cells may list status parameters such as Current Delay behind Live Feed 510, “LIVE/RECORDED” program status 515, Disk Gas Gauge 520, Set Out-of-Disk (OOD) Alert 525, Program Length vs. Storage Capacity, and File Attributes 535. These features are only exemplary of the many other possible status features or parameters of the STB 300 that a user may display in order to review.

To view the desired status parameter, and/or to manipulate or display additional information such as sub menus, icons, animated icons or other graphical displays such as bar-graphs, pie-charts, etc. associated with a particular status parameter, the viewer simply presses a designated key on the remote control 400 or on the STB 300, such as a scroll down key, left/right or up/down arrow button, for example, in order to highlight a specific cell. The status parameter of the highlighted cell may then be actuated or implemented on the display by pressing an execution key, button, etc. on the remote control 400 or STB 300, such as an “action”, “enter” or “execution” key as is known in the art. The present invention is not limited to these user command interfaces, of course, as any of the other exemplary user command interfaces may be implemented as well.

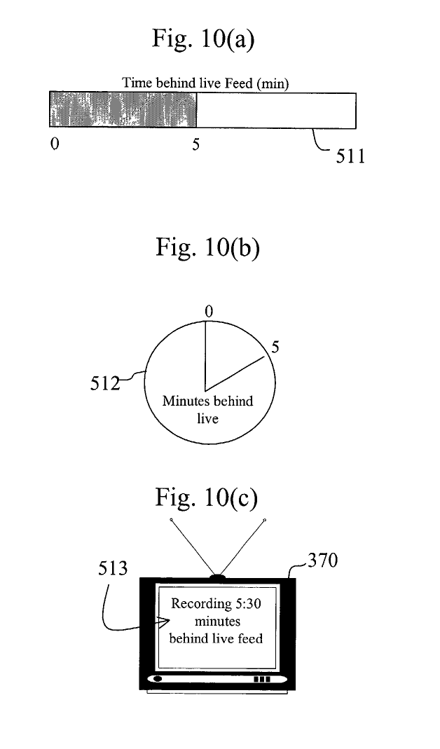

FIGS. 10(a) through 10(c) illustrates several exemplary graphics that may represent the current delay status parameter of the invention. A viewer may select the Current Delay behind Live Feed cell 510 if the viewer has paused a live broadcast. This may be done by actuating a pause button on remote control 400, sending a signal to host processor 310 to direct the A/V data of the live feed being received by transport processor 330 to be buffered in SDRAM 315 via bus 305. During pause mode up to 30 minutes of a live broadcast may be buffered or cached (recorded) in SDRAM 315 and/or HDD 320, depending on the storage requirement. A freeze frame displaying the final frame processed may be shown in the pause mode. Further, the viewer may resume the live broadcast simply be pressing a button on the remote control 400 or STB 300 to resume live broadcast, in effect “jumping forward” to the current live broadcast.

During pause mode, if a viewer desires to see how far the recording is behind the live broadcast, the viewer displays the status menu 500 and actuates the Current Delay behind Live Feed cell 510 as previously described above. In lieu of the status menu 500, there may be provided a designated key or button on remote control 400 or STB 300 which actuates processing to display the graphics corresponding to the current delay status parameter.

As shown in FIG. 10(a), once the Current Delay behind Live Feed cell 510 is selected, a simple horizontal window or bar graph 511 may be displayed on the screen of display device 370, calibrated in units of time such as minutes (or minutes and seconds) and labeled “Time Behind Live Feed”, with a portion of the window shaded to depict the current delay. Alternatively, this may be displayed as a pie chart graphic object 512 as shown in FIG. 10(b), or as a text message 513 that overlays the frozen frame on the screen of display device 370, which may be a TV as shown in FIG. 10(c). Moreover, a suitable icon, or plurality of interactive or animated icons indicating the time behind live feed may also be displayed, such as two human icon forms running one behind the other in a line, the rear icon labeled “Recording”, the front labeled “Live Feed” for example, with the rear icon also depicting a time in minutes behind, or minutes and seconds behind, being labeled thereon as well.

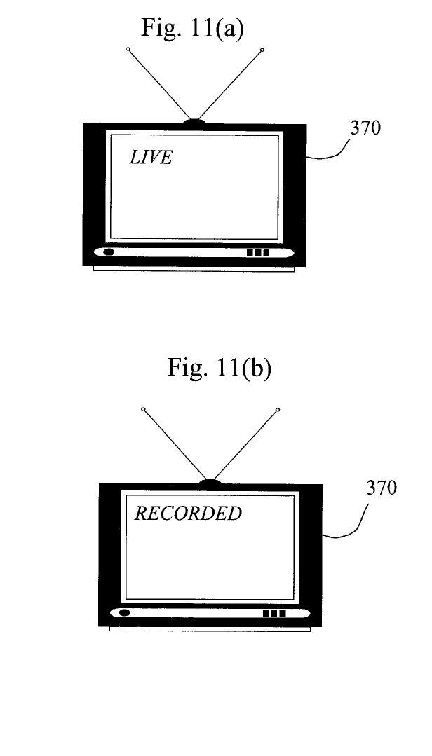

FIGS. 11(a) and 11(b) illustrates exemplary graphical objects that may represent the live/recorded status indicator parameter of the present invention. A viewer may desire to see if a program he or she is watching is LIVE (a live feed) or RECORDED. To do so, the viewer may display the status menu 500 and select the “LIVE/RECORDED” program status cell 515 as previously described above. Thereafter, and as shown in FIGS. 11(a) and 11(b), the word LIVE or RECORDED will flash on the screen of display device 370 (shown as a TV here), indicating the status of the program being viewed. So as not to annoy the viewer, this status parameter may be displayed for a designated period of time, preferably a short time such as about 5 seconds or so, before disappearing. In lieu of the status menu 500, there may be provided a designated key or button on remote control 400 or STB 300 which actuates processing to directly display LIVE or RECORDED on the screen of display 370, without having to first display and then manipulate status menu 500 to select the “LIVE/RECORDED” program status cell 515.

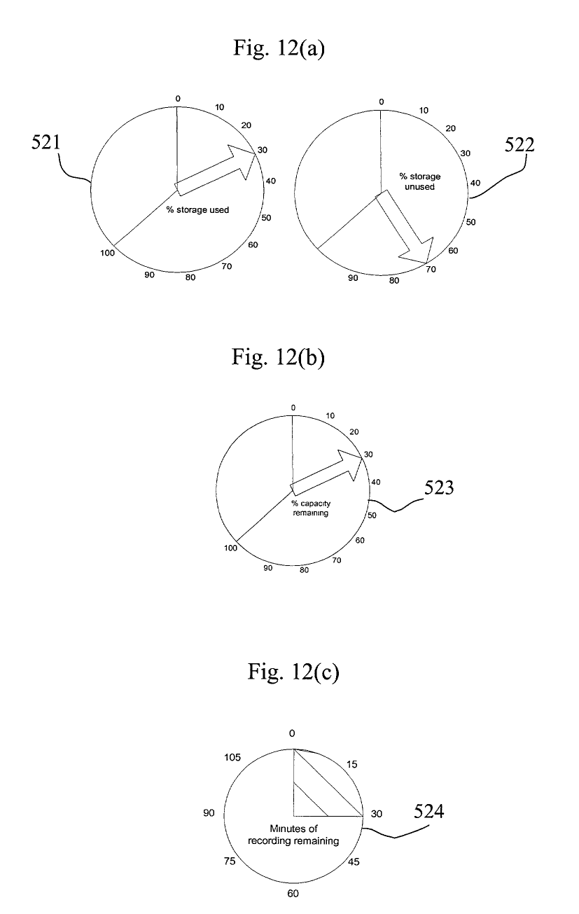

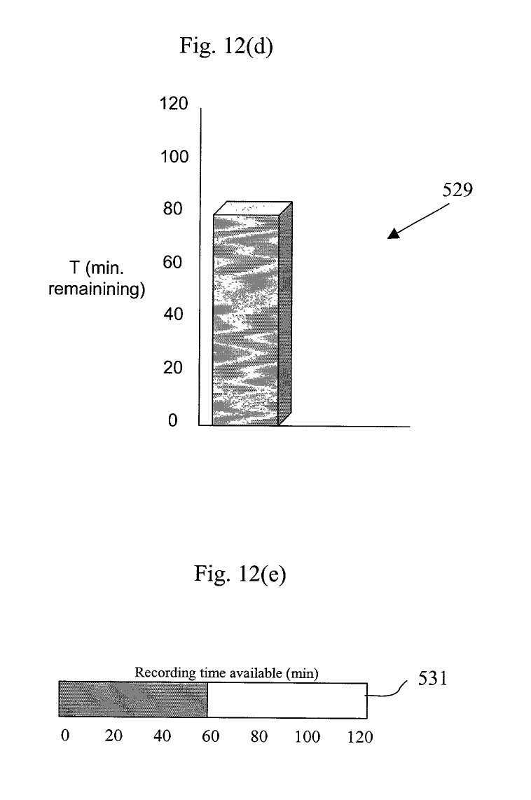

FIGS. 12(a) through 12(e) illustrate several exemplary graphical objects that may represent the Disk Gas Gauge status parameter of the invention. The Disk Gas Gauge status parameter generally indicates the percent of the HDD 320 that has been consumed by recorded material. Once selected, the Disk Gas Gauge may be displayed in various forms. In FIG. 12(a), two icons (gauges 521 and 522) representing “percent used” and “percent unused” may be displayed on display device 370. These two icons may alternatively depict “recording time used” and “remaining recording time available” in lieu of percent used/unused.

As shown in FIG. 12(b), a single gauge icon 523 may be displayed to represent only the “percent capacity remaining” of HDD 320. Alternatively, a pie-chart 524 depicting the amount of recording time remaining, in minutes and/or minutes and hours may be displayed as shown in the shaded portion of FIG. 12(c). Additionally, a simple bar graph 529 may indicate “percent of HDD 320's capacity unused”, or more preferably “available recording time remaining” in minutes, as shown in FIG. 12(d). Or as shown in FIG. 12(e), a horizontal of vertical window 531 somewhat similar to that shown in FIG. 10(a) regarding the current delay status parameter may be provided, with the remaining available recording time shaded within the window. The present invention is not limited to these graphical objects or icons, as other graphical forms and objects may be used as well.

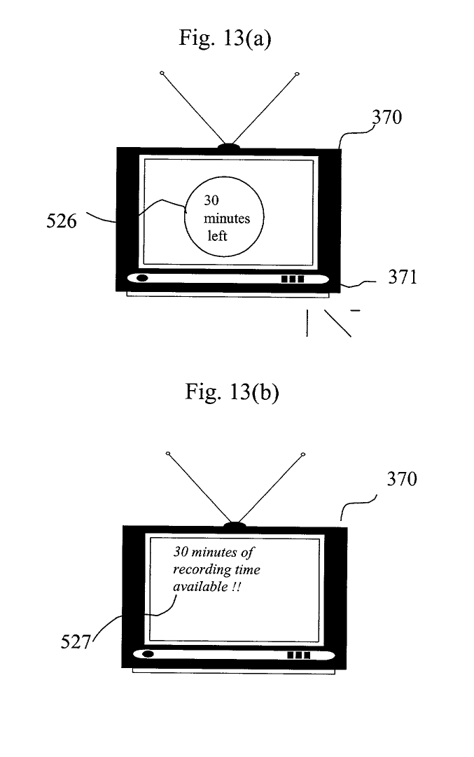

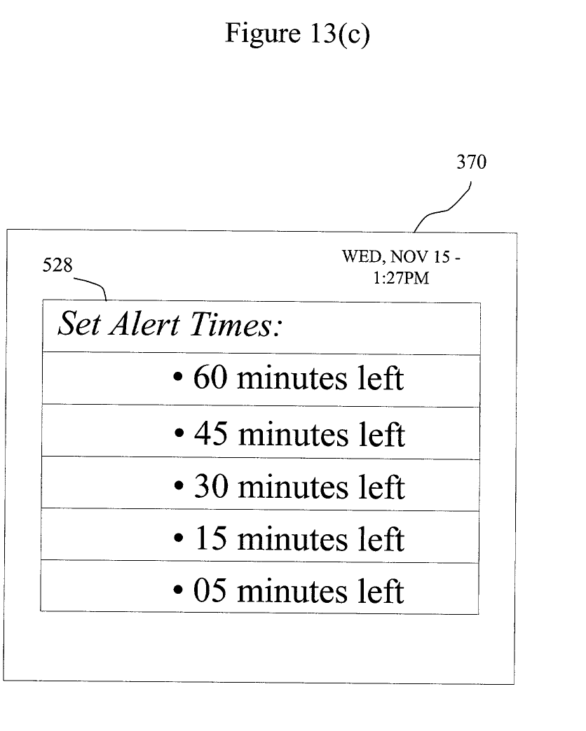

FIGS. 13(a) through 13(c) illustrates several exemplary graphics that may represent the out-of-disk space alert status parameter of the invention. For the out-of-disk space alert, the user may receive a notification indicating the approximate minutes of recording time still available while recording is in progress. This out-of-disk space alert may appear automatically on display device 370, to be triggered when the remaining recording time available decreases to a default value that is preset in SDRAM 315, such as thirty (30) minutes for example.

As shown in FIG. 13(a) this alert may be a flashing icon 526, that may also be accompanied by a warning sound or tone. The tone is generated by host processor 310 to be output via transport processor 330, PCI I/F 340, AC-3/MPEG Audio decoder 356, DAC 372 for conversion prior to being output from a speaker 371 of display device 370, for example. The flashing icon 526 may visually indicate that 30 minutes of recording time remain available. Alternatively, a simple text message 527 may be displayed, as shown in FIG. 13(b). The present invention is not limited to these graphical objects or icons, as other graphical forms and objects may be used as well.

FIG. 13(c) illustrates a sub menu associated with the out-of-disk space alert status parameter in accordance with the invention. As an additional feature, as percent of HDD 320 consumed by recorded material (or remaining recording time available) reaches lower levels, different video icons/shapes may be displayed to visually alert the viewer, which also may be accompanied with warning tones or sounds. For example, alerts may be generated for display on display device 370 at 45 minutes, 30 minutes, 15 minutes and 5 minutes of remaining recording time available. These alert times may be selected by the user or viewer by accessing the status menu 500 and selecting the Set Out-of-Disk (OOD) Alert cell 525. Thereafter, and as shown in FIG. 13(c), a submenu 528 may be displayed in which the user highlights those alerts that he/she desires, and then presses an action or execute button provided on the remote control 400 or STB 300. Until changed, these out-of-disk space alerts become the defaults for STB 300.

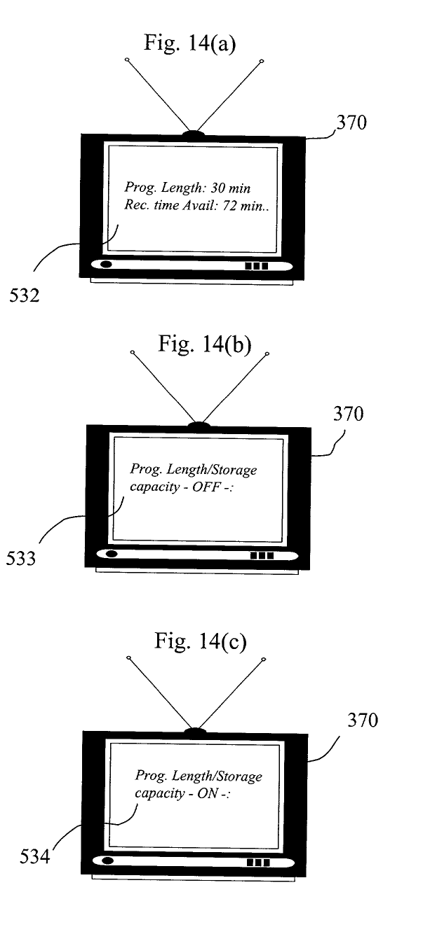

FIG. 14(a) through 14(c) illustrate exemplary text messages of a status parameter related to program length versus recording time available. In another embodiment, if the program length is greater than the amount of unused HDD 320 space available, the user may receive a notification indicating such, as well as the recording time available, prior to or at the start of the recording. This is determined by a algorithm preset within host processor 310, which compares the program length of a desired event or broadcast that is to be recorded with the remaining storage capacity in HDD 320.

FIG. 14(a) illustrates an exemplary notification text message 532 that may be displayed in on overlain fashion on the program that has begun to be recorded, informing the user of the program length as well as the recording time available. Although this status feature is preferably automatically set as a default in the host processor 310 at time of manufacture of the STB 300, so as to be displayed prior to or at the start of the recording, the user may also elect to inactivate this feature. FIG. 14(b) illustrates an exemplary text message 533 associated with inactivating this feature. For example, a key or button on remote control 400 or STB 300 may send a command to host processor 310 to inactivate this notification, whereby a text message such as “Program Length/Storage Capacity OFF” is briefly displayed on display device 370. To re-activate the notification, the user simply presses the same key or button on remote control 400 or STB 300, whereby a text message 534 such as “Program Length/Storage Capacity ON” is briefly displayed on display device 370. This is illustrated in FIG. 14(c).

The present invention is not limited to the graphical text messages illustrated in FIGS. 14(a)-(c) in order to inform the user of the program length as well as the recording time available, as other graphical forms such as icons or animated icons may be used as well. For example, the status menu 500 of FIG. 9 may also include a program length versus storage capacity cell 530, which as a default is set to “ON” so that the notification is automatically displayed prior to or at time of recording a desired program. The user may inactivate this notification simply by selecting cell 530 on menu 500, and then to actuate an execute button or key provided on remote control 400 or STB 300 to change the status from “ON” to “OFF”. This will be reflected in cell 530. To re-activate the notification, the user simply highlights cell 530 and punches the aforementioned execute button or key.

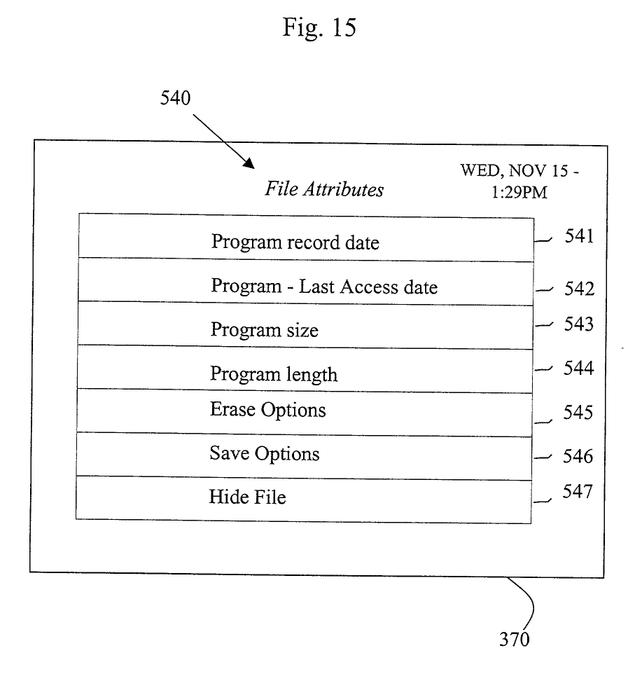

FIG. 15 illustrates an exemplary status sub-menu screen related to certain file attributes according to the invention. A viewer may wish to review or manipulate certain file attributes of the STB 300. To do so, the viewer may display the status menu 500 and select the “FILE ATTRIBUTES” program status cell 535 as previously described above.

As shown in FIG. 15, a submenu 540 entitled “FILE ATTRIBUTES” may be displayed on the display device 370. Submenu 540 might include cells designating certain features or status parameters. The user would scroll down submenu 540 to highlight a desired cell in order to review or manipulate the information or data corresponding to the selected cell. Algorithms or software well known in the art for determining the parameters corresponding to the cells in submenu 540 are under the control of host processor 310, and are implemented based on a command from a command user interface such as remote control 400.

These cells may include the date a program is recorded cell 541, a latest or last date a stored program has been accessed cell 542, size of a recorded or live program cell 543 in Mbytes, length of a live or recorded program in minutes cell 544, erase options cell 545 for implementation of a protect feature to prevent erasure of a recorded program, save options cell 546 designating how much of a program is to be recorded and/or how long of a time a program is to be stored before being erased, and a hide file cell 547 for implementation of a hidden file feature to prevent titles of certain programs, such as those of an explicit nature, for example, from being displayed within the program guide.

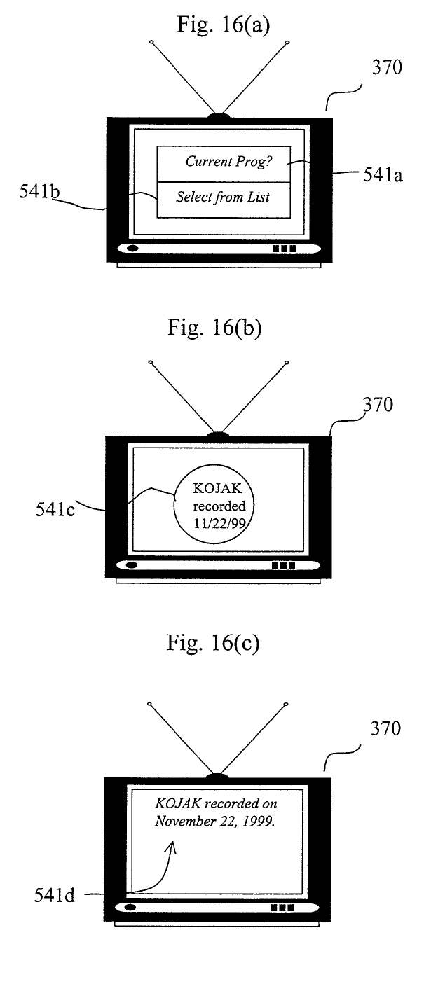

FIGS. 16(a) through 16(c) illustrate the information that may be displayed upon selection of cell 541 in FIG. 15. If a user selects the date recorded cell 541, the user may be prompted to select the recorded date from the currently viewed recorded program (cell 541a) or to select a recorded program from the program guide list (a browse function—see cell 541b), as shown in FIG. 16(a). The use simply selects the desired cell to display the date information corresponding to the chosen program. This may be displayed as a icon or test message 541c or 541d for example, as shown in FIGS. 16(b) and 16(c).

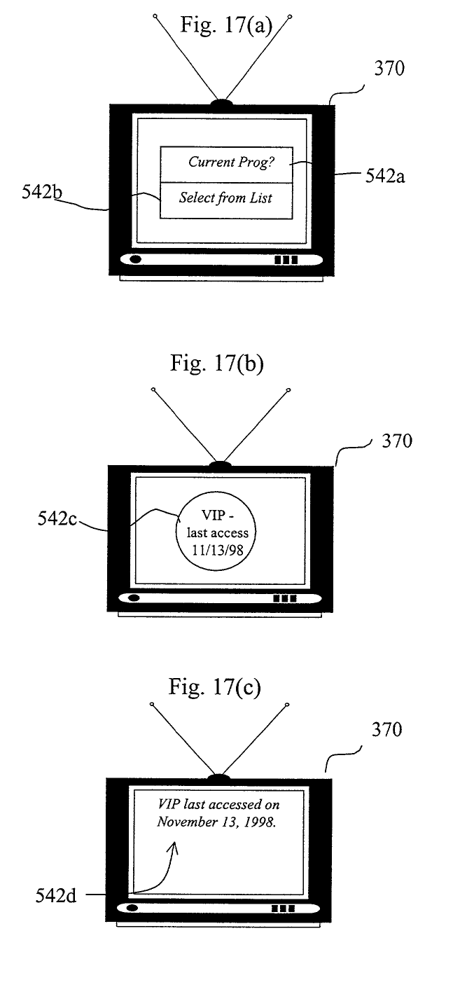

FIGS. 17(a) through 17(c) illustrate the information that may be displayed upon selection of cell 542 in FIG. 15. If a user selects the latest date accessed cell 541, the user may be prompted to select from the currently viewed recorded program (cell 542a) or to select a recorded program from the program guide list (a browse function—see cell 542b), as shown in FIG. 17(a). The use simply selects the desired cell to display the latest access date information corresponding to the chosen program. This may be displayed as a icon or test message 542c or 542d for example, as shown in FIGS. 17(b) and 17(c).

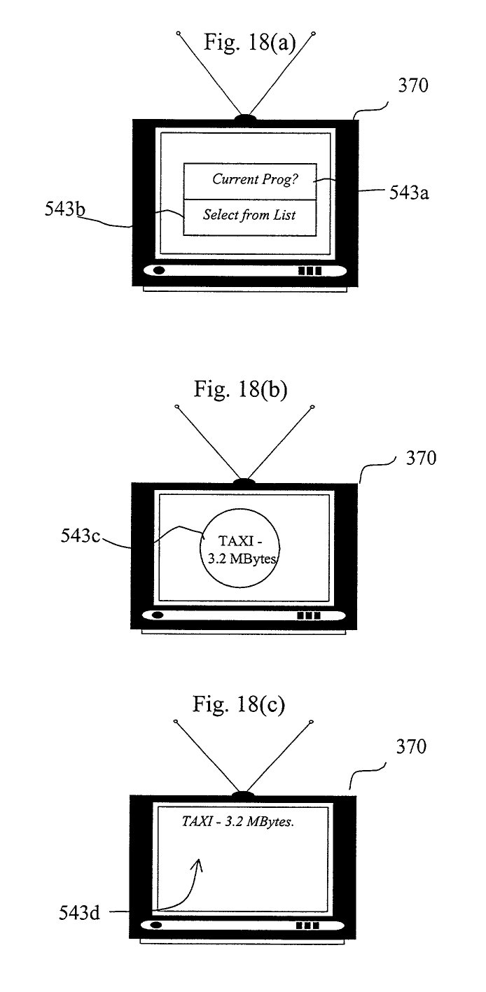

FIGS. 18(a) through 18(c) illustrate the information that may be displayed upon selection of cell 543 in FIG. 15. Like FIGS. 16(a) and 17(a), if a user selects the Program Size cell 543, the user may be prompted to select from the currently viewed live or recorded program (cell 543a) or to select a recorded program from the program guide list (a browse function—see cell 543b), as shown in FIG. 17(a). The use simply selects the desired cell to display the program size information corresponding to the chosen program. This may displayed as a icon or test message 543c or 543d for example, as shown in FIGS. 18(b) and 18(c).

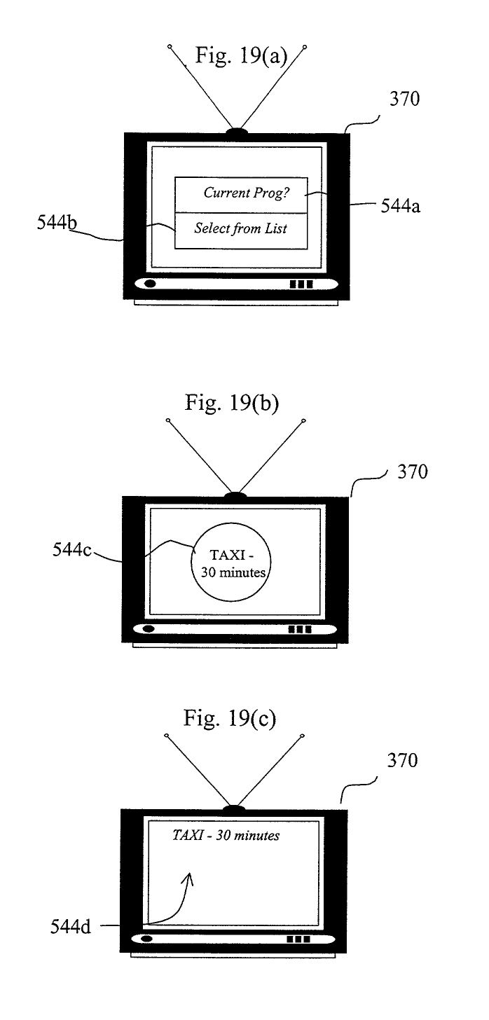

FIGS. 19(a) through 19(c) illustrate the information that may be displayed upon selection of cell 544 in FIG. 15. Similar to the above, if a user selects the Program Length cell 544, the user may be prompted to select from the currently viewed live or recorded program (cell 544a) or to select a recorded program from the program guide list (a browse function—see cell 544b), as shown in FIG. 19(a). The use simply selects the desired cell to display the program size information corresponding to the chosen program. This may displayed as a icon or test message 544c or 544d for example, as shown in FIGS. 19(b) and 19(c).

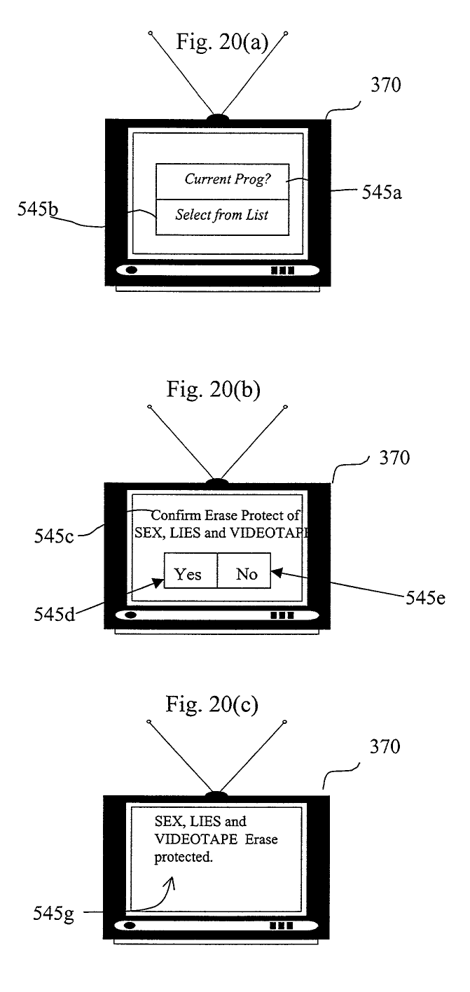

Should the user choose the prevent erase cell 545, subcells and/or test messages such as shown in FIGS. 20(a) through 20(c) may be displayed. In FIG. 20(a), the user will be prompted for the desired program to protect, to be selected from the currently viewed live or recorded program (cell 545a), or from the list (cell 545b). Once selected, a confirmation message 545d will be displayed, prompting to user to verify that the selected program (the title shown here as “SEX, LIES and VIDEOTAPES” will be protected from erasure. The user simply highlights the “YES” subcell 545e or “NO” subcell 545f. Thereafter, an icon or test message 545g may be displayed indicating that “SEX, LIES and VIDEOTAPES” is protected. This is shown in FIG. 20(c).

Should the user choose the prevent erase cell 545, subcells and/or test messages such as shown in FIGS. 20(a) through 20(c) may be displayed. In FIG. 20(a), the user will be prompted for the desired program to protect, to be selected from the currently viewed live or recorded program (cell 545a), or from the list (cell 545b). As shown in FIG. 20(b), once selected, a confirmation message 545c will be displayed, prompting to user to verify that the selected program (the title shown here as “SEX, LIES and VIDEOTAPES” will be protected from erasure. The user simply highlights the “YES” subcell 545d or “NO” subcell 545e. Thereafter, an icon or test message 545g may be displayed indicating that “SEX, LIES and VIDEOTAPES” is protected. This is shown in FIG. 20(c).

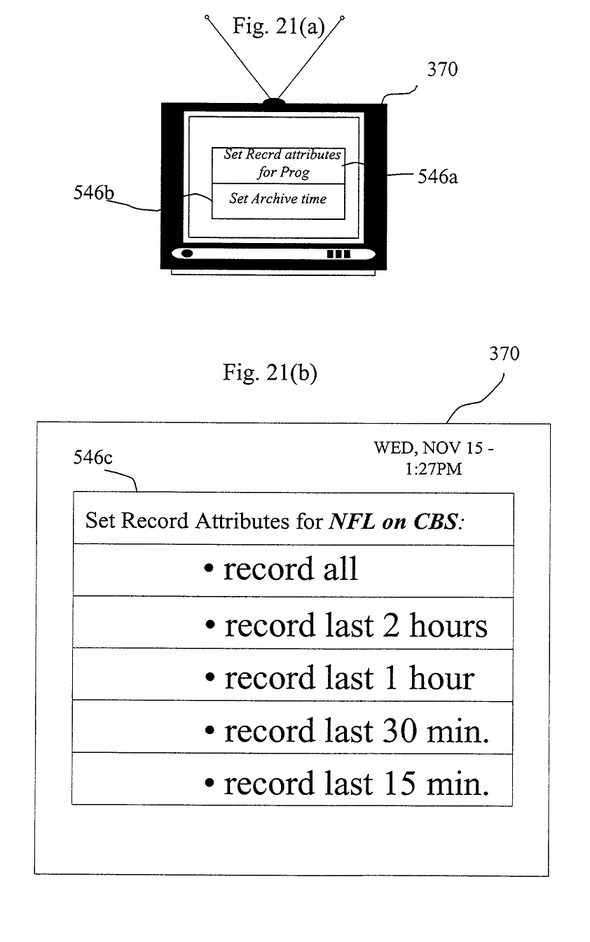

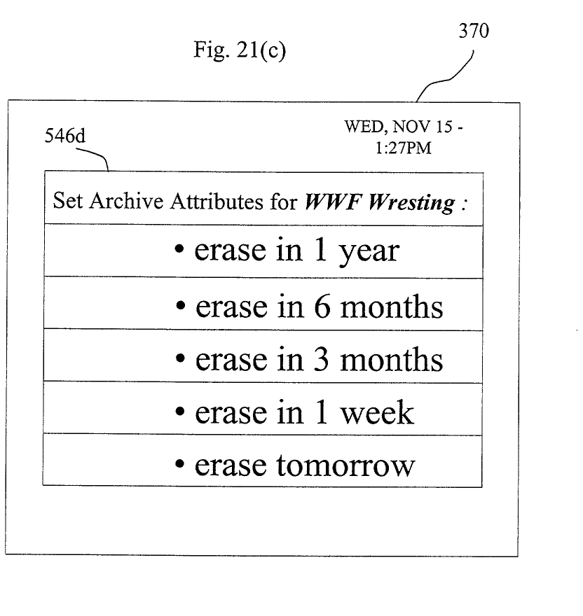

FIGS. 21(a) through 21(c) illustrate the information that may be displayed upon selection of cell 546 in FIG. 15. When the user selects the save options cell 546 designating how much of a program is to be recorded and/or how long of a time a program is to be stored before being erased, subcells 546a and 546b are displayed, as shown in FIG. 21(a). The viewer would select cell 546a only if he wants to record a portion of a currently or soon to be viewed program, broadcast or event. Selecting 546a requires the user to enter the title of the desired program, which can be accessed from the program guide list (not shown) as is well known in the art. Once the program is selected, a text message and/or submenu 546c is displayed on the screen of display device 370, as shown in FIG. 21(b). The use may then select the desired portion or part of the broadcast to record by choosing on of the subcells.

If cell 546b is selected, the user will be prompted for the desired program title, to be selected from the currently viewed live or recorded program, or from browsing a program guide list as described above. Once selected, a text message and/or submenu 546d is displayed on the screen of display device 370, as shown in FIG. 21(c). The user may then select the desired time at which the recorded program (or to be recorded program) is to remain archived before being erased.

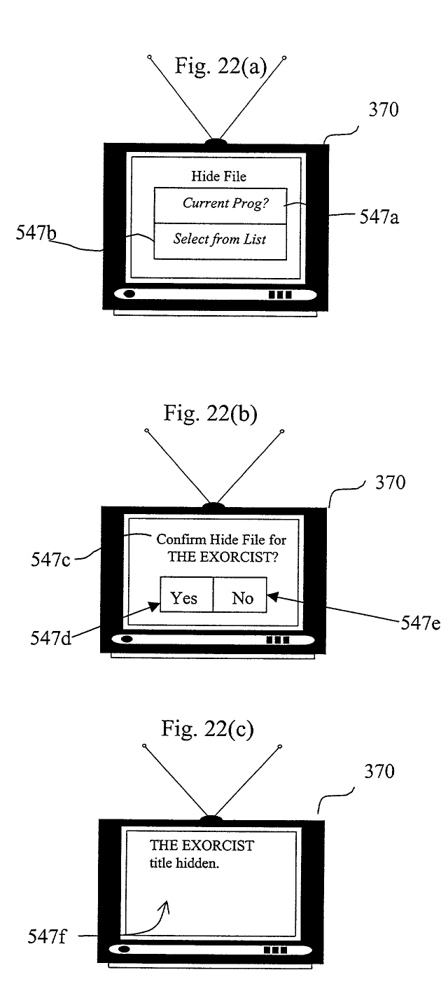

FIGS. 22(a)-(c) illustrate the information that may be displayed upon selection of cell 547 in FIG. 15. Similar to the above, if cell 547 is selected, the user is prompted for program title information, as shown in cells 547a and 547b of FIG. 22(a). As shown in FIG. 22(b), the user selects the desired program to hide, and a confirmation message 545c will be displayed, prompting to user to verify that the title of the selected program (the title shown here is “THE EXORCIST”) is hidden from a program guide list that is viewed by a user. The user simply highlights the “YES” subcell 547de or “NO” subcell 547e. Thereafter, an icon or test message 547f may be displayed indicating that “THE EXORCIST” will be hidden. This is shown in FIG. 20(c).

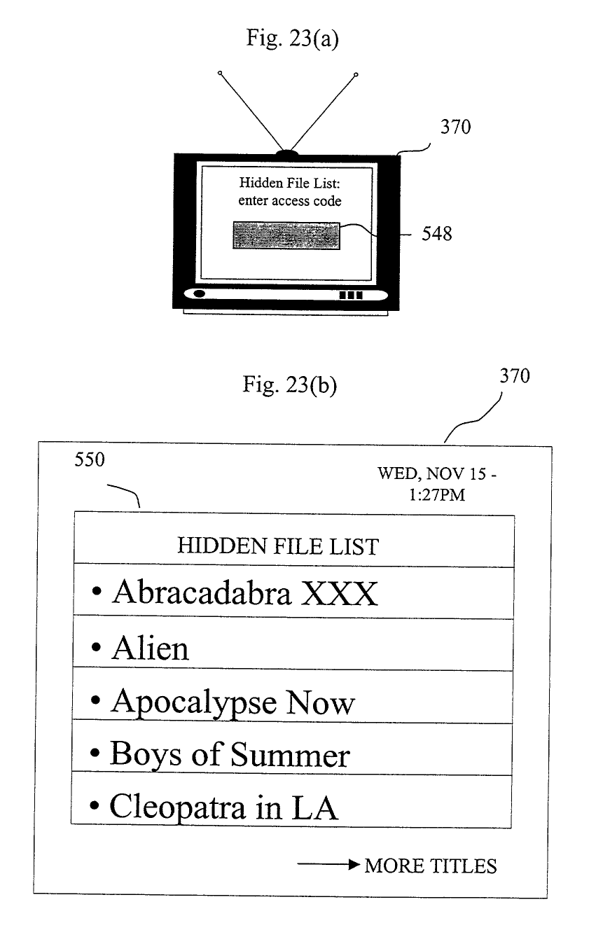

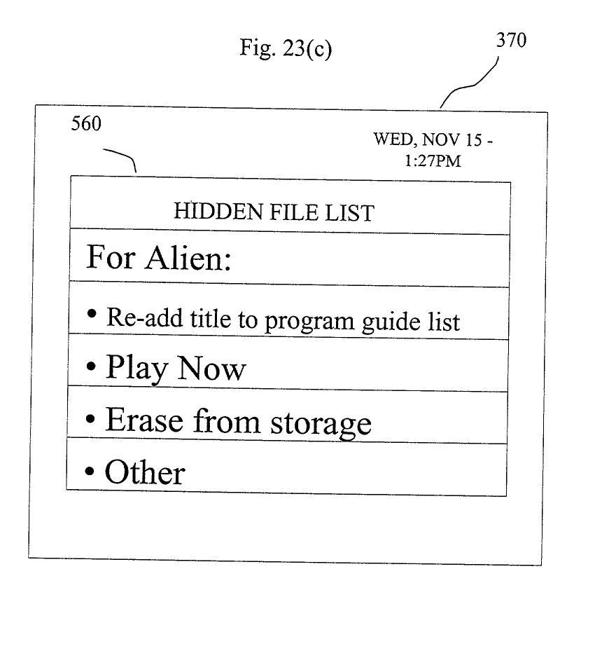

FIGS. 23(a) to 23(c) illustrates how the user may display a list of hidden files for selection. To access this hidden title, a user may have to enter a security code to view all “hidden titles”. This feature provides the ability to hide titles of programs in the program guide list that may be explicit in nature and unsuitable for minors to view. This feature may be provided on the Main Menu 500 of FIG. 9 for example, or may be displayed on display device 370 via a direct command from remote control 400.

For example, if a user manipulates a particular key or function button on remote control 400, a text message such as “Hidden File List: enter access code:” may be displayed, as shown in FIG. 23(a). The user keys in the code in the highlighted window 548 and presses an execute button on the remote control 400. Thereafter, a menu 550 entitled Hidden File List may appear with a listing of all titles in the program guide that have been hidden, as shown in FIG. 23(b). The user may scroll down and select a desired title. After selection, a message or submenu 560 may then be displayed for enabling a user to perform functions such as adding the title back to the main program guide list, playing the selected program, erasing the selected program, etc. This is shown in FIG. 23(c).

Therefore, the status display apparatus in accordance with the present invention requires an interface such as a remote control 400, to send commands to a processor (host processor 310) which in turn retrieves a selected status parameter from a memory (SDRAM 315) for display on a display device 370, for example. Conveniently, the host processor 310 and SDRAM 315 are contained within STB 300 so as to monitor, update where necessary, and store status parameters of the STB 300, with the display device 370 operatively connected to STB 300 to display the desired status parameters or features.

Further, since a viewer may be provided with a display of the aforementioned status parameters of his or her own STB equipped with DVR, he or she may more easily decide what programs to record, or may be alerted that some of the previously recorded material may have to be erased in order to provide room for recording a desired event, program or broadcast that exceeds the current storage capacity of a mass storage device such as HDD 320.

The invention being thus described, it will be obvious that the same may be varied in many ways. For example, functional blocks in FIGS. 3-8 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s). Such variations are not to be regarded as departure from the spirit and scope of the invention, and all such modifications as would be obvious to one skilled in the art are intended to be included within the scope of the following claims.

What is claimed is:

1. An apparatus for displaying the status of a digital video recording device, comprising:
a memory for storing a plurality of selectable status parameters indicating functionality of the digital video recording device;
a processor for controlling a display of said plurality of status parameters based on received commands to access said memory, so as display at least a selected one of the plurality of status parameters.

2. The status display apparatus of claim 1, wherein an interface enables a user to send said commands to display said selected status parameter via said processor.

3. The status display apparatus of claim 2, wherein said interface is selected from a remote control device, or from execution keys or buttons provided on the digital video recording device.

4. The status display apparatus of claim 1, wherein said memory and processor are contained within the digital video recording device.

5. The status display apparatus of claim 1, wherein said processor controls display of a status menu for selection of at least one the plurality of status parameters based on reception of a command to display the status menu by a user.

6. The status display apparatus of claim 5, wherein the user manipulates keys of a remote control to transmit commands to said processor to display said status menu on a display device operatively connected to the digital video recording device, and further manipulates said remote control to graphically select a status parameter from said displayed status menu for display.

7. The status display apparatus of claim 1,
wherein a user manipulates designated keys or buttons of a remote control device, each designated key or button corresponding to each of said selectable plurality of status parameters, and
wherein the manipulated key or button causes the correspondingly selected status parameter to be displayed on a display device operatively connected to the digital video recording device.

8. The status display apparatus of claim 1,
wherein a user manipulates designated keys or buttons provided on the digital video recording device, each designated key or button corresponding to each of said selectable plurality of status parameters, and
wherein the manipulated key or button causes the correspondingly selected status parameter to be displayed on a display device operatively connected to the digital video recording device.

9. The status display apparatus of claim 1, wherein one of said plurality of selectable status parameters is a current delay feature which displays how far a recording is behind a live broadcast when a signal corresponding to the live broadcast is paused.

10. The status display apparatus of claim 9, wherein the current delay feature is displayed as at least one of an icon, pie-chart and text message form.

11. The status display apparatus of claim 1, wherein one of said plurality of selectable status parameters is a live/recorded status feature that displays whether a program being viewed is either live or recorded.

12. The status display apparatus of claim 11, wherein the word “LIVE” or “RECORDED” is displayed in flashing form for a finite period of time, depending on the status of the program being viewed.

13. The status display apparatus of claim 1, wherein one of said plurality of selectable status parameters is a disk gas gage feature indicating how much of a mass storage device operatively connected to the digital video recording device is consumed by recorded material.

14. The status display apparatus of claim 13, wherein said disk gas gauge feature is displayed in at least one of icon, pie-chart and bar-graph form and indicates the percent of the mass storage device capacity used, and/or the percent of the mass storage device capacity that is unused.

15. The status display apparatus of claim 13, wherein said disk gas gauge feature is displayed in at least one of icon, pie-chart and bar-graph form and indicates the available recording time remaining before the mass storage device is full.

16. The status display apparatus of claim 13, wherein said mass storage device is selected from the group comprising at least a hard disk drive, a magnetic storage device and an optical storage device.

17. The status display apparatus of claim 1, wherein one of said plurality of selectable status parameters is a notification indicating the approximate minutes of recording time still available while recording is in progress.

18. The status display apparatus of claim 17, wherein said notification is embodied as an out-of-disk space alert feature which is automatically displayed when the remaining available recording time equals a predetermined default value.

19. The status display apparatus of claim 18, wherein said out-of-disk space alert is displayed when there are thirty minutes of remaining available recording time.

20. The status display apparatus of claim 18, wherein said out-of-disk space alert may be set to be displayed at various levels of remaining available recording time by a user selecting and displaying a sub-menu for setting out-of-disk space alerts.

21. The status display apparatus of claim 17, wherein said notification indicating the approximate minutes of recording time still available is displayed as an animated icon on a display device operatively connected to the digital video recording device.

22. The status display apparatus of claim 18, wherein said out-of-disk space alert has both a video and audio component.

23. The status display apparatus of claim 1, wherein one of said plurality of selectable status parameters is a notification indicating the program length of a desired program to record and the approximate minutes of recording time still available while for recording.

24. The status display apparatus of claim 23, wherein said notification is automatically displayed prior to or at the start of recording the desired program.

25. The status display apparatus of claim 24, wherein said notification is displayed as text message on a display device operatively connected to the digital video recording device.

26. The status display apparatus of claim 1, wherein one of said plurality of selectable status parameters is an attributes list which directs the user to other status parameters for display and manipulation, said other status parameters including at least one of a date a program is recorded, a latest date that a stored program has been accessed, size of a recorded or live program, length of a live or recorded program, protect feature to prevent erasure of a recorded program, save options designating how much of a program is to be recorded and/or how long of a time a program is to be stored before being erased, and implementation of a hidden file feature to prevent titles of certain programs from being displayed on a program guide list.

27. A method of displaying the status of a digital video recording device on a display device operatively connected thereto, comprising:
storing a plurality of selectable status parameters indicating functionality of the digital video recording device within a memory of the digital video recording device;
receiving commands to display at least a selected one of the plurality of status parameters; and
accessing said memory to display said selected one of the plurality of status parameters on the display device based on said received commands.

28. The status display method of claim 27, further comprising controlling display of a status menu on said display device for selection of at least one the plurality of status parameters based on said received commands.

29. The status display method of claim 28, further comprising transmitting said received commands by manipulating keys of a remote control so as to display said status menu on said display device, and further manipulating said keys to graphically select a status parameter from said displayed status menu for display.

30. The status display method of claim 27, further comprising manipulating designated keys or buttons of a remote control device, each designated key or button corresponding to each of said selectable plurality of status parameters, wherein the manipulated key or button sends said command to display said selected status parameter on said display device.

31. The status display method of claim 27, further comprising manipulating designated keys or buttons provided on the digital video recording device, each designated key or button corresponding to each of said selectable plurality of status parameters, wherein the manipulated key or button sends said command to display said selected status parameter on said display device.

32. In a system having a digital video recording device, an apparatus for displaying the status of the digital video recording device on a display device operatively connected to the digital video recording device, comprising:
a memory for storing a plurality of selectable status parameters indicating functionality of the digital video recording device; and
a processor for controlling a display of said plurality of status parameters based on received commands to access said memory so as display at least a selected one of the plurality of status parameters.

33. The system of claim 32, wherein said memory and processor are contained within the digital video recording device.
